(19) United States
(12) Patent Application Publication
(10) Pub. No.: US 2026/0349288 A1
(43) Pub. Date: Nov. 5, 2026

(54) SEMICONDUCTOR DEVICE

(71) Applicant: SAMSUNG ELECTRONICS CO., LTD., Suwon-si (KR)

(72) Inventors: Byungeun YUN, Suwon-si (KR); Seungkuk KANG, Suwon-si (KR); Kwansik CHO, Suwon-si (KR); Seokhee HWANG, Suwon-si (KR)

(73) Assignee: SAMSUNG ELECTRONICS CO., LTD., Suwon-si (KR)

(21) Appl. No.: 19/371,195

(22) Filed: Oct. 28, 2025

(30) Foreign Application Priority Data
Apr. 30, 2025 (KR) 10-2025-0057478

(51) Int. Cl. G02F 1/025; G02F 1/01

(52) U.S. Cl. CPC G02F 1/025; G02F 1/0147

(57) ABSTRACT

A semiconductor device comprises a substrate; a first insulating layer on the substrate; an optical waveguide on the first insulating layer; a second insulating layer on the first insulating layer; a plurality of first insulating patterns extending from the second insulating layer toward the substrate and spaced apart from each other in a first direction parallel to an upper surface of the substrate; a second insulating pattern disposed on the substrate and penetrating the first insulating layer and the second insulating layer; and an air gap disposed in the substrate and interposed between the plurality of first insulating patterns. Each of the plurality of first insulating patterns penetrates the substrate. An upper surface of the second insulating pattern is located at a higher level than the upper surface of the optical waveguide.

### CROSS-REFERENCE TO RELATED APPLICATIONS

This U.S. non-provisional patent application claims priority under 35 U.S.C. § 119 to Korean Patent Application No. 10-2025-0057478, filed on Apr. 30, 2025, in the Korean Intellectual Property Office, the entire contents of which are hereby incorporated by reference.

### BACKGROUND OF THE INVENTION

The present invention relates to a semiconductor device, and more specifically, to a semiconductor device that includes an optical waveguide.

With the rapid increase in computational capacity and data capacity driven by the widespread adoption of high-performance computers, smart devices, and various multimedia technologies, there is an increasing demand for the high-speed data processing technologies in both wired and wireless communication fields. To meet the requirements of next-generation data communication modules—characterized by ultra-compact size, ultra-high-speed, low-power consumption, and low-cost—silicon photonics technology, which utilizes light for data transmission, is gaining significant attention in the field of wired communication systems.

### SUMMARY

Some embodiments of the present inventive concepts provide a semiconductor device with improved mechanical stability.

According to an embodiment of the inventive concept, a semiconductor device may comprise a substrate, a first insulating layer on the substrate, an optical waveguide on the first insulating layer, a second insulating layer on the first insulating layer, a plurality of first insulating patterns extending from the second insulating layer toward the substrate and spaced apart from each other in a first direction parallel to an upper surface of the substrate, a second insulating pattern disposed on the substrate and penetrating the first insulating layer and the second insulating layer; and an air gap disposed in the substrate and interposed between the plurality of first insulating patterns, wherein each of the plurality of first insulating patterns penetrates the substrate, wherein an upper surface of the second insulating pattern is located at a higher level than the upper surface of the optical waveguide.

According to an embodiment of the inventive concept, a semiconductor device may comprise a substrate, a first insulating layer on the substrate, an optical waveguide on the first insulating layer, a second insulating layer on the first insulating layer, a plurality of first insulating patterns extending from the second insulating layer toward the substrate and spaced apart from each other in a first direction parallel to an upper surface of the substrate, a plurality of second insulating patterns disposed on the substrate and penetrating the first insulating layer and the second insulating layer; and an air gap disposed in the substrate and interposed between the plurality of first insulating patterns, wherein each of the plurality of first insulating patterns penetrates the substrate, wherein each of the plurality of second insulating patterns is interposed between the plurality of first insulating patterns, wherein the optical waveguide is interposed between the plurality of second insulating patterns.

According to an embodiment of the inventive concept, a semiconductor device may comprise a substrate, a first insulating layer on the substrate, an optical waveguide on the first insulating layer, a second insulating layer on the first insulating layer and covering the optical waveguide, a plurality of first insulating patterns extending from the second insulating layer toward the substrate and spaced apart from each other in a first direction parallel to an upper surface of the substrate, a second insulating pattern disposed on the substrate and penetrating through the first insulating layer and the second insulating layer, an air gap disposed in the substrate and interposed between the plurality of first insulating patterns; and a heater on the second insulating layer, wherein the optical waveguide vertically overlaps the air gap, wherein each of the plurality of first insulating patterns penetrates the substrate, wherein an upper surface of the second insulating pattern is located at a higher level than an upper surface of the optical waveguide.

### BRIEF DESCRIPTION OF THE DRAWINGS

FIG. 1 is a top view of a semiconductor device according to an embodiment of the inventive concept.

FIG. 2 is a cross-sectional view according to A-A′ of FIG. 1.

FIG. 3 is a cross-sectional view according to B-B′ of FIG. 1.

FIGS. 4A through 8B are cross-sectional views illustrating a method of manufacturing a semiconductor device according to an embodiment of the inventive concept, where FIGS. 4A, 5A, 6A, 7A, and 8A correspond to A-A′ of FIG. 1, and FIGS. 4B, 5B, 6B, 7B, and 8B correspond to B-B′ of FIG. 1.

FIGS. 9 and 10 are cross-sectional views of a semiconductor device according to an embodiment of the inventive concept, where FIG. 9 is a cross-sectional view according to A-A′ in FIG. 1, and FIG. 10 is a cross-section view according to B-B′ in FIG. 1.

FIGS. 11A and 11B are cross-sectional views illustrating a method of manufacturing a semiconductor device according to an embodiment of the inventive concept, where FIG. 11A is a cross-sectional view according to A-A′ of FIG. 1, and FIG. 11B is a cross-section view according to B-B′ of FIG. 1.

FIG. 12 is a top view of a semiconductor device according to an embodiment of the inventive concept.

FIG. 13 is a cross-sectional view according to A-A′ of FIG. 12.

FIG. 14 is a cross-sectional view according to B-B′ of FIG. 12.

FIG. 15 is a top view of a semiconductor device according to an embodiment of the inventive concept.

FIG. 16 is a cross-sectional view according to A-A′ of FIG. 15.

FIG. 17 is a cross-sectional view according to B-B′ of FIG. 15.

FIG. 18 is a cross-sectional view of a semiconductor device according to an embodiment of the inventive concept, in accordance with A-A′ of FIG. 15.

FIG. 19 is a cross-sectional view of a semiconductor device according to an embodiment of the inventive concept, in accordance with B-B′ of FIG. 15.

### DETAILED DESCRIPTION

Example embodiments of the inventive concepts will now be described more fully with reference to the accompanying drawings, in which example embodiments are shown. Same reference numerals in the drawings denote same elements, and thus their description will be omitted.

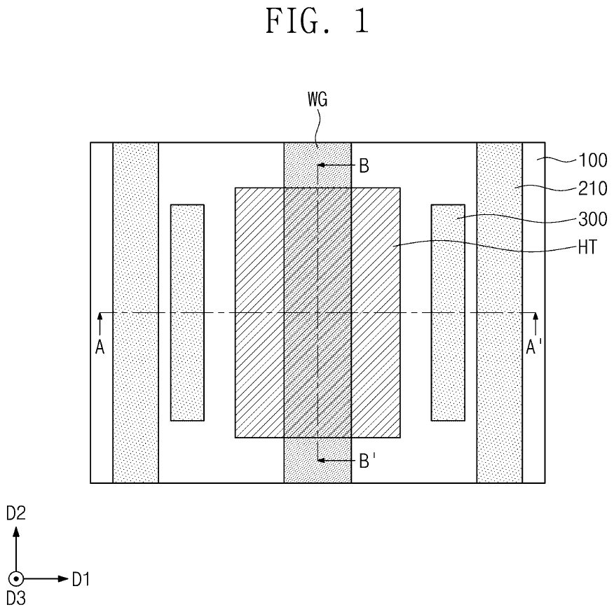

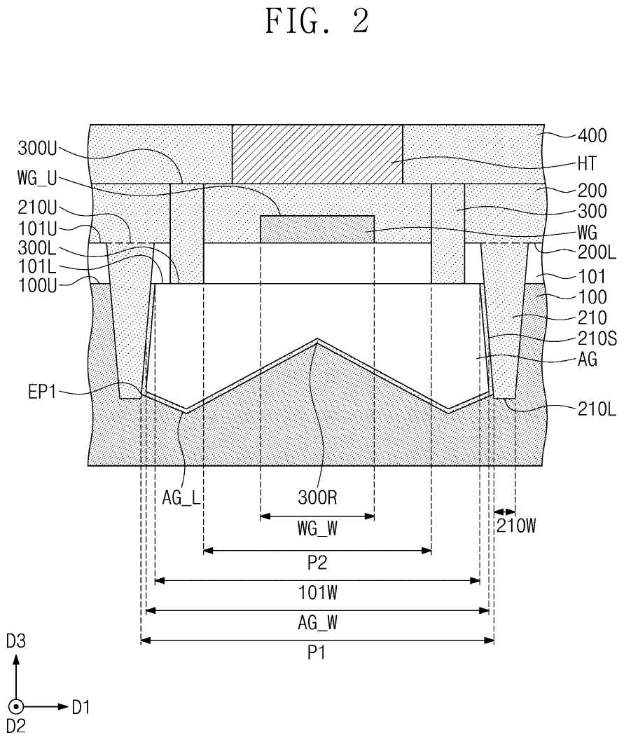

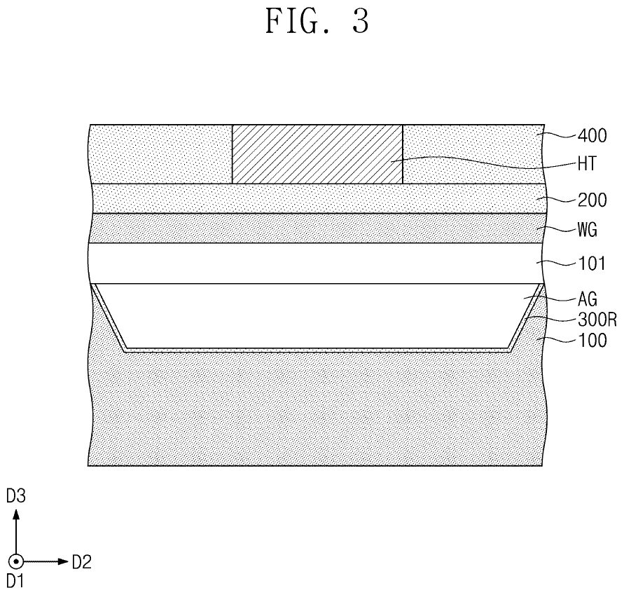

FIG. 1 is a top view of a semiconductor device according to an embodiment of the inventive concept. FIG. 2 is a cross-sectional view according to A-A′ of FIG. 1. FIG. 3 is a cross-sectional view according to B-B′ of FIG. 1.

Referring to FIGS. 1 to 3, a first insulating layer 101 may be disposed on a substrate 100. The substrate 100 may be a semiconductor substrate. The substrate 100 may be, for example, a silicon substrate, a germanium substrate, and/or a silicon-germanium substrate, or the like.

The first insulating layer 101 may cover an upper surface 100U of the substrate 100. It may be a buried oxide (BOX) formed by a separation by implanted oxygen (SIMOX) method or a bonding and layer transfer method. The first insulating layer 101 may include, for example, silicon oxide.

A second insulating layer 200 may be disposed on the first insulating layer 101. The second insulating layer 200 may include a plurality of first insulating patterns 210 extending from a lower surface 200L of the second insulating layer 200 toward the substrate 100. The second insulating layer 200 may include, for example, silicon oxide.

Each of the plurality of first insulating patterns 210 may extend from the lower surface 200L of the second insulating layer 200 toward the substrate 100 in a third direction D3 perpendicular to the upper surface 100U of the substrate 100. Each of the plurality of first insulating patterns 210 may penetrate the first insulating layer 101 and the substrate 100. A width 210W of each of the plurality of first insulating patterns 210 in a first direction D1, which is a direction parallel to the upper surface 100U of the substrate 100, may become smaller toward a lower surface 210L of each of the plurality of first insulating patterns 210.

The plurality of first insulating patterns 210 may be spaced apart from each other in the first direction D1. The plurality of first insulating patterns 210 may be spaced apart from each other by a first distance P1 in the first direction D1. The first distance P1 may increase as it approaches the lower surface 210L of each of the plurality of first insulating patterns 210. A minimum of the first distance P1 may occur, for example, at an upper surface 210U of each of the plurality of first insulating patterns 210. The upper surface 210U of each of the plurality of first insulating patterns 210 may refer to a portion of the lower surface 200L of the second insulating layer 200 that vertically corresponds to the lower surface 210L of each of the first insulating patterns 210. A maximum of the first distance P1 may occur, for example, at the lower surface 210L of each of the plurality of first insulating patterns 210.

A second insulating pattern 300 may be disposed on the substrate 100, and may penetrate the first insulating layer 101 and the second insulating layer 200. The second insulating pattern 300 may be provided in plural. The present invention may not be limited to the number of the second insulating patterns 300. A single number or a plurality of the second insulating patterns 300 may be provided.

An upper surface 300U of each of the plurality of second insulating patterns 300 may be positioned at a higher level than an upper surface 101U of the first insulating layer 101. The upper surface 300U of each of the plurality of second insulating patterns 300 may be located at a higher level than the upper surface 210U of each of the plurality of first insulating patterns 210.

Each of the plurality of second insulating patterns 300 may be interposed between the plurality of first insulating patterns 210. Each of the plurality of second insulating patterns 300 may be spaced apart from each other in the first direction D1. Each of the plurality of second insulating patterns 300 may be spaced apart from each other by a second distance P2 in the first direction D1. The second distance P2 may be smaller than the first distance P1. The plurality of second insulating patterns 300 may include, for example, silicon oxide.

An optical waveguide WG may be disposed on the first insulating layer 101 and may extend in a second direction D2 parallel to the upper surface 100U of the substrate 100 and intersecting the first direction D1. An upper surface WG_U of the optical waveguide WG may be located at a higher level than the upper surface 210U of each of the plurality of first insulating patterns 210. The upper surface WG_U of the optical waveguide WG may be located at a lower level than the upper surface 300U of each of the plurality of second insulating patterns 300. The second insulating layer 200 may cover the optical waveguide WG. The second insulating layer 200 may be in contact with the optical waveguide WG and may cover the upper surface WG_U and a side surface of the optical waveguide WG. The optical waveguide WG may be interposed between the first insulating layer 101 and the second insulating layer 200.

The optical waveguide WG may be interposed between the plurality of first insulating patterns 210 and may be interposed among the plurality of second insulating patterns 300. The optical waveguide WG may be spaced apart from each of the plurality of first insulating patterns 210 in the first direction D1, and may be spaced away from each of the second insulating patterns 300 in the first direction D1. A width WG_W of the optical waveguide WG in the first direction D1 may be smaller than the first distance P1 and smaller than the second distance P2. The optical waveguide WG may include a semiconductor material, and may include, for example, silicon.

A heater HT may be disposed on the second insulating layer 200. The heater HT may be disposed on the optical waveguide WG, and may overlap the optical waveguide WG vertically (for example, in the third direction D3). The heater HT may transfer heat to the optical waveguide WG, thereby changing the refractive index of the optical waveguide WG. The refractive index of the optical waveguide WG may be adjusted through the heater HT to control the phase of light passing through the optical waveguide WG. The heater HT may include a conductive material, and may include, for example, at least one of chromium (Cr), gold (Au), titanium nitride (TiN), or an alloy thereof.

A third insulating layer 400 may be disposed on the second insulating layer 200. The third insulating layer 400 may cover the heater HT. The third insulating layer 400 may include the same material as the second insulating layer 200, for example, and may include silicon oxide.

An air gap AG may be disposed in the substrate 100 and may be interposed between the plurality of first insulating patterns 210. The air gap AG may overlap the optical waveguide WG and the heater HT vertically (for example, in the third direction D3). Accordingly, heat generated by the heater HT may be effectively transferred to the optical waveguide WG. The air gap AG may effectively trap the heat, so that the heat may be efficiently transferred to the optical waveguide WG.

The air gap AG may expose a portion of a lower surface 101L of the first insulating layer 101 and the lower surface 300L of each of the plurality of second insulating patterns 300. The air gap AG may expose a side surface 210S of each of the plurality of first insulating patterns 210. The exposed side surfaces 210S of the plurality of first insulating patterns 210 may face each other in the first direction D1.

The air gap AG may expose the side surface 210S of each of the plurality of first insulating patterns 210 from the lower surface 101L of the first insulating layer 101 to a first point EP1 of each of the first insulating patterns 210. The air gap AG may not expose the side surface 210S of each of the plurality of first insulating patterns 210 from the lower surface 210L of each of the first insulating patterns 210 to the first point EP1. The first point EP1 may mean a point located at the lowest level among the side surfaces 210S of each of the plurality of first insulating patterns 210 exposed by the air gap AG.

A width AG_W of the air gap AG in the first direction D1 may be greater than the width WG_W of the optical waveguide WG in the first direction D1. The width AG_W of the air gap AG may increase as it becomes closer to the first point EP1 from the lower surface 101L of the first insulating layer 101. The width AG_W of the air gap AG in the first direction D1 may decrease as it approaches the lower surface 210L of each of the plurality of first insulating patterns 210 from the first point EP1. A maximum of the width AG_W of the air gap AG in the first direction D1 may occur at the first point EP1.

The maximum of the width AG_W of the air gap AG in the first direction D1 may be greater than a length 101W of the lower surface 101L of the exposed first insulating layer in the first direction D1. The width AG_W of the air gap AG in the first direction D1 may be smaller than or equal to the first distance P1. The width AG_W of the air gap AG in the first direction D1 at the same level may be smaller than or equal to the first distance P1. The maximum of the width AG_W of the air gap AG in the first direction D1 may be less than the maximum of the first distance P1. The first distance P1, which is a separation distance between the plurality of first insulating patterns 210, may define a size of the air gap AG.

At least a portion of a lowermost surface AG_L of the air gap AG may be located at a lower level than the lower surface 210L of each of the plurality of first insulating patterns 210. A plurality of lowermost surfaces AG_L of the air gap AG may be provided. Each of the plurality of lowermost surfaces AG_L of the air gap AG may overlap each of the plurality of second insulating patterns 300 vertically (for example, the third direction D3). The air gap AG may expose the (111) surface of the substrate 100. The air gap AG may expose the (111) surface of the silicon. The air gap AG may have a V shape with respect to the lowermost surface AG_L.

According to the embodiment of the inventive concept, the air gap AG may be interposed between the plurality of first insulating patterns 210. A size of the air gap AG may be defined by the plurality of first insulating patterns 210. The air gap AG may not be excessively formed. The mechanical stability of the semiconductor device may be improved. In a post-processing such as package assembly, a defect such as breakage of the semiconductor device may not occur.

An insulating liner 300R may be disposed on the substrate 100 exposed by the air gap AG. The insulating liner 300R may extend along the exposed substrate 100 and may cover the side surface 210S of the plurality of exposed first insulating patterns 210. In contrast to the illustrated example, there may be no interface between the insulating liner 300R and the plurality of first insulating patterns 210. The insulating liner 300R may be interposed between the air gap AG and the substrate 100, and may be interposed therebetween. The insulating liner 300R may include the same material as the second insulating pattern 300. The insulating liner 300R may include, for example, silicon oxide.

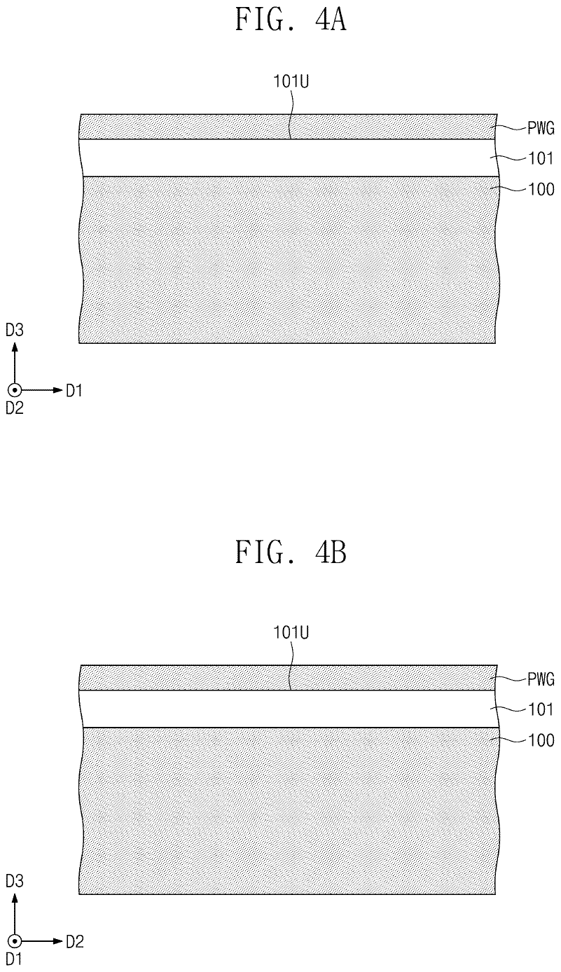

FIGS. 4A through 8B are cross-sectional views illustrating a method of manufacturing a semiconductor device according to the embodiment of the inventive concept. FIGS. 4A, 5A, 6A, 7A, and 8A correspond to A-A′ of FIG. 1, and FIGS. 4B, 5B, 6B, 7B, and 8B correspond to B-B′ of FIG. 1. For simplicity of description, content overlapping with the content described with reference to FIGS. 1 to 3 is omitted.

Referring to FIGS. 4A and 4B, the first insulating layer 101 may be formed on the substrate 100. A preliminary optical waveguide layer PWG may be formed on the first insulating layer 101. The preliminary optical waveguide layer PWG may cover the upper surface 101U of the first insulating layer 101 and may extend in the first direction D1 and the second direction D2. The preliminary optical waveguide layer PWG may include a semiconductor material and may include silicon.

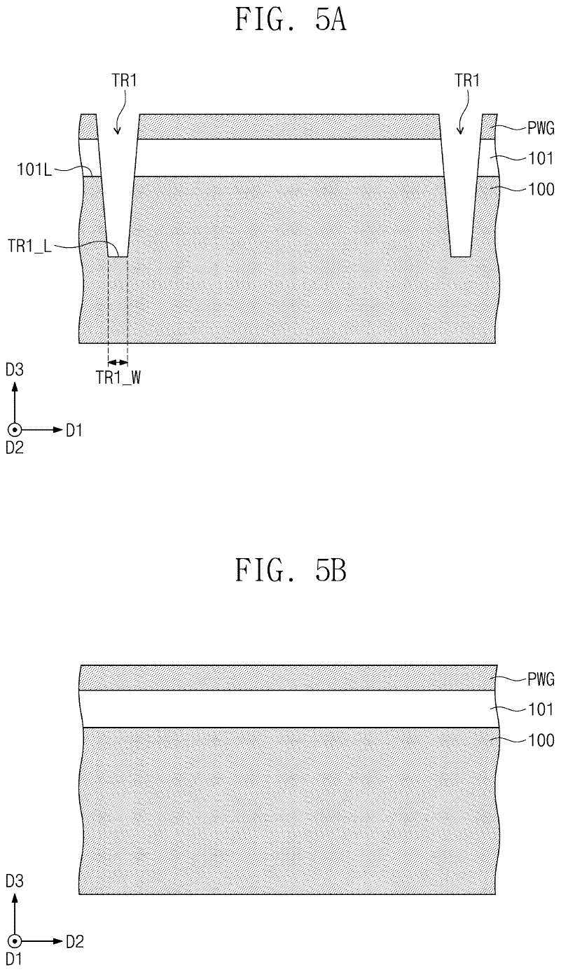

Referring to FIGS. 5A and 5B, a plurality of first trenches TR1 may be formed through the preliminary optical waveguide layer PWG, the first insulating layer 101, and the substrate 100. The plurality of first trenches TR1 may be spaced apart from each other in the first direction D1. A width TR1_W of each of the plurality of first trenches TR1 in the first direction D1 may be smaller as it is closer to a lower surface TR1_L of each of the plurality of first trenches TR1. The lower surface TR1_L of each of the plurality of first trenches TR1 may be located at a lower level than a lower surface 101L of the first insulating layer 101. Forming the plurality of first trenches TR1 may include, for example, forming a first mask pattern on the preliminary optical waveguide layer PWG, and using the first mask pattern as an etching mask to etch the preliminary optical waveguide layer PWG, the first insulating layer 101, and the substrate 100. The etching process may be, for example, a wet etching process.

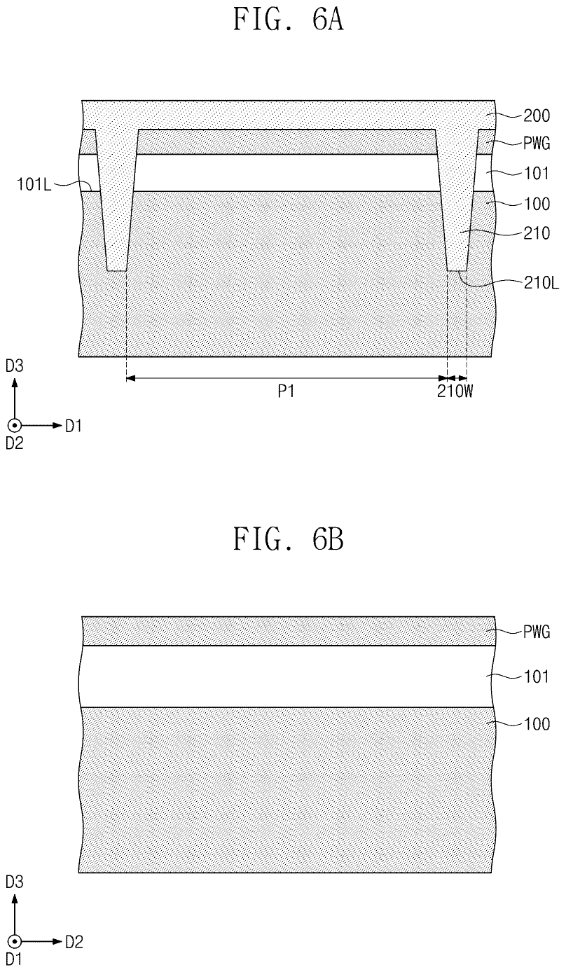

Referring to FIGS. 6A and 6B, the second insulating layer 200 may be formed on the first insulating layer 101, and each of the plurality of first insulating patterns 210 may be formed in each of the plurality of first trenches TR1.

Each of the plurality of first insulating patterns 210 may be formed through the preliminary optical waveguide layer PWG, the first insulating layer 101, and the substrate 100. The lower surface 210L of each of the plurality of first insulating patterns 210 may be located at a lower level than the lower surface 101L of the first insulating layer 101. A width 210W of each of the plurality of first insulating patterns 210 in the first direction D1 may be smaller as it becomes closer to the lower surface 210L of each of the first insulating patterns 210. The plurality of first insulating patterns 210 may be spaced apart from each other in the first direction D1. The plurality of first insulating patterns 210 may be spaced apart from each other by a first distance P1 in the first direction D1.

Forming the second insulating layer 200 and the plurality of first insulating patterns 210 may include, for example, filling the plurality of first trenches TR1 and the first insulating layer 101 with an insulating material.

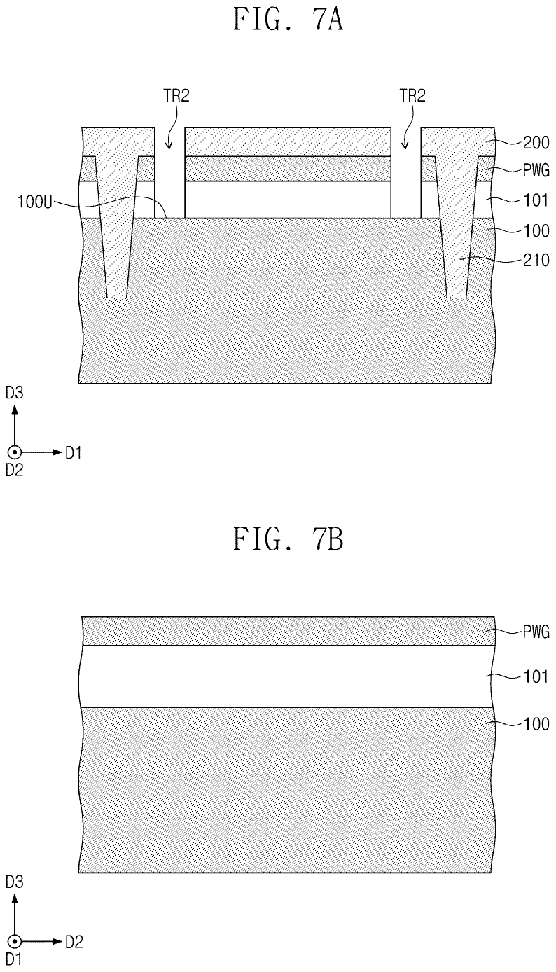

Referring to FIGS. 7A and 7B, a plurality of second trenches TR2 may be formed through the second insulating layer 200, the preliminary optical waveguide layer PWG, and the first insulating layer 101. Each of the plurality of second trenches TR2 may expose the upper surface 100U of the substrate 100. Each of the plurality of second trenches TR2 may be interposed between the plurality of first insulating patterns 210 and may be spaced apart from each other in the first direction D1. Forming the plurality of second trenches TR2 may include, for example, forming a second mask pattern on the second insulating layer 200, and using the second mask pattern as an etching mask to etch the second insulating layer 200, the preliminary optical waveguide layer PWG, and the first insulating layer 101. However, the inventive concept is not limited to the number of the plurality of second trenches TR2. A single number of the second trenches TR2 may be provided.

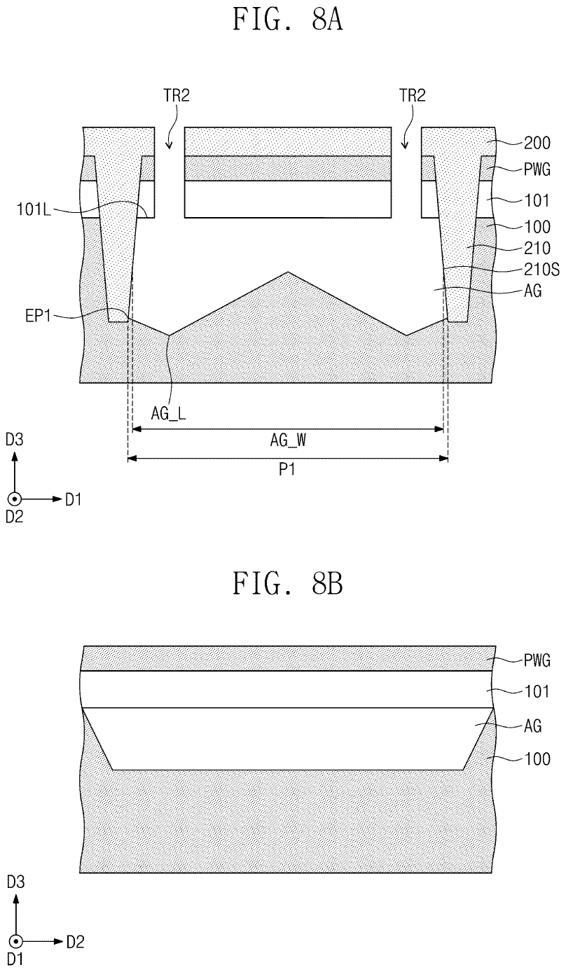

Referring to FIGS. 8A and 8B, the air gap AG may be formed between the plurality of first insulating patterns 210 and may be formed in the substrate 100. The air gap AG may expose the side surface 210S of each of the plurality of first insulating patterns 210 and the lower surface 101L of the first insulating layer 101. The side surfaces 210S of the plurality of exposed first insulating patterns 210 may face each other in the first direction D1.

The air gap AG may expose the side surface 210S of each of the plurality of first insulating patterns 210 from the lower surface 101L of the first insulating layer 101 to the first point EP1 of each of the plurality of first insulating patterns 210. The air gap AG may not expose the side surface 210S of each of the plurality of first insulating patterns 210 from the lower surface 210L of each of the plurality of first insulating patterns 210 to the first point EP1.

The width AG_W of the air gap AG in the first direction D1 may increase as it becomes closer to the first point EP1 from the lower surface 101L of the first insulating layer 101. The width AG_W of the air gap AG in the first direction D1 may decrease as it becomes closer to the lower surface 210L of each of the plurality of first insulating patterns 210 at the first point EP1.

The width AG_W of the air gap AG in the first direction D1 may be smaller than or equal to the first distance P1. More specifically, the width AG_W of the air gap AG in the first direction D1 at the same level may be smaller than or equal to the first distance P1. The maximum of the width AG_W of the air gap AG in the first direction D1 may be smaller than the maximum of the first distance P1. The first distance P1, which is a separation distance between the plurality of first insulating patterns 210, may define the size of the air gap AG.

The lowermost surface AG_L of the air gap AG may be located at a lower level than the lower surface 210L of each of the plurality of first insulating patterns 210. The plurality of lowermost surfaces AG_L of the air gap AG may be formed. Each of the plurality of lowermost surfaces AG_L of the air gap AG may overlap each of the plurality of second trenches TR2 vertically (for example, the third direction D3).

Forming the air gap AG may include, for example, an anisotropic wet etch process that provides an etchant through the plurality of second trenches TR2. The etching process may expose the (111) surface of silicon of the substrate 100. The (111) surface of the silicon has the lowest etching rate, and the air gap AG may expose the (111) surface of silicon. Thus, the air gap AG may have a V shape with respect to the lowermost surface AG_L of the air gap AD.

According to the embodiment of the inventive concept, the air gap AG may be interposed between the plurality of first insulating patterns 210. The size of the air gap AG may be defined by the plurality of first insulating patterns 210. For this reason, the air gap AG may not be excessively formed. The mechanical stability of the semiconductor device may be improved. In a post-process such as package assembly, a defect such as breakage of the semiconductor device may not occur.

Referring again to FIGS. 1 through 3, the plurality of second insulating patterns 300 may be formed filling a plurality of second trenches TR2. Each of the plurality of second insulating patterns 300 may penetrate the second insulating layer 200 and the first insulating layer 101. The lower surface 300L of each of the plurality of second insulating patterns 300 may be exposed by the air gap AG.

The insulating liner 300R may extend along the substrate 100 exposed by the air gap AG, and the insulating liner 300R may be formed on each side surface 210S of the plurality of first insulating patterns 210. The plurality of second insulating patterns 300 and the insulating liner 300R may include the same material as each other. Forming the plurality of second insulating patterns 300 and the insulating liner 300R may include, for example, filling the plurality of second trenches TR2 with an insulating material.

The optical waveguide WG may be formed on the first insulating layer 101 and may be formed to overlap the air gap AG vertically (for example, in the third direction D3). The upper surface WG_U of the optical waveguide WG may be located at a lower level than the upper surface 300U of each of the plurality of second insulating patterns 300. Forming the optical waveguide WG may include, for example, forming a third mask pattern on the second insulating layer 200, and patterning the preliminary optical waveguide layer PWG using the third mask pattern as an etching mask. However, the inventive concept is not limited to the order of formation of the optical waveguide WG. The optical waveguide WG may be formed after forming the plurality of second insulating patterns 300 or before forming the plurality of first trenches TR1.

The heater HT may be formed on the second insulating layer 200 and the optical waveguide WG. The heater HT may be formed to overlap the optical waveguide WG and the air gap AG vertically (for example, in the third direction D3). The third insulating layer 400 may cover the heater HT and be formed on the second insulating layer 200.

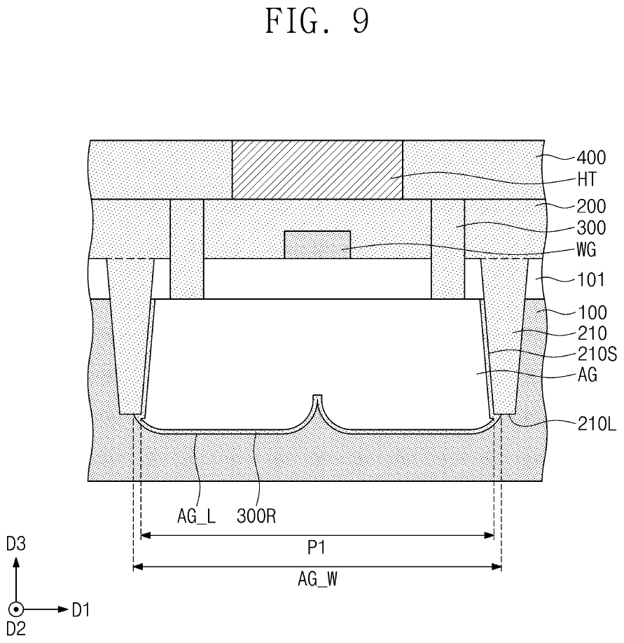

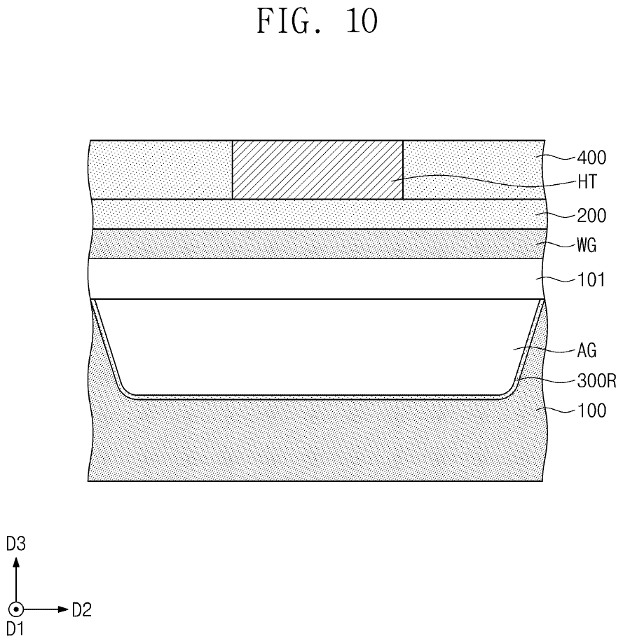

FIGS. 9 and 10 are cross-sectional views of a semiconductor device according to the embodiment of the inventive concept. FIG. 9 is a cross-sectional view according to A-A′ in FIG. 1. FIG. 10 is a cross-section view according to B-B′ in FIG. 1. For simplicity of description, details overlapping with the semiconductor device described with reference to FIGS. 1 to 3 are omitted.

Referring to FIGS. 9 and 10, the air gap AG may be disposed in the substrate 100 and may be interposed between the plurality of first insulating patterns 210. The lowermost surface AG_L of the air gap AG may be located at a level lower than the lower surface 210L of each of the plurality of first insulating patterns 210. The lower surface AG_L of the air gap AG may be rounded.

The air gap AG may expose the side surface 210S of each of the plurality of first insulating patterns 210, and may expose a portion of the lower surface 210L of each of the first insulating patterns 210. The maximum of the width AG_W of the air gap AG in the first direction D1 may be greater than the maximum of the first distance P1.

The insulating liner 300R may cover each side surface 210S of the plurality of first insulating patterns 210 and may extend along the substrate 100 exposed by the air gap AG. The insulating liner 300R may cover the exposed lower surface 210L of each of the plurality of first insulating patterns 210. Unlike shown, there may be no interface between the insulating liner 300R and the plurality of first insulating patterns 210.

Other configurations may be substantially the same as the semiconductor device described with reference to FIGS. 1-3.

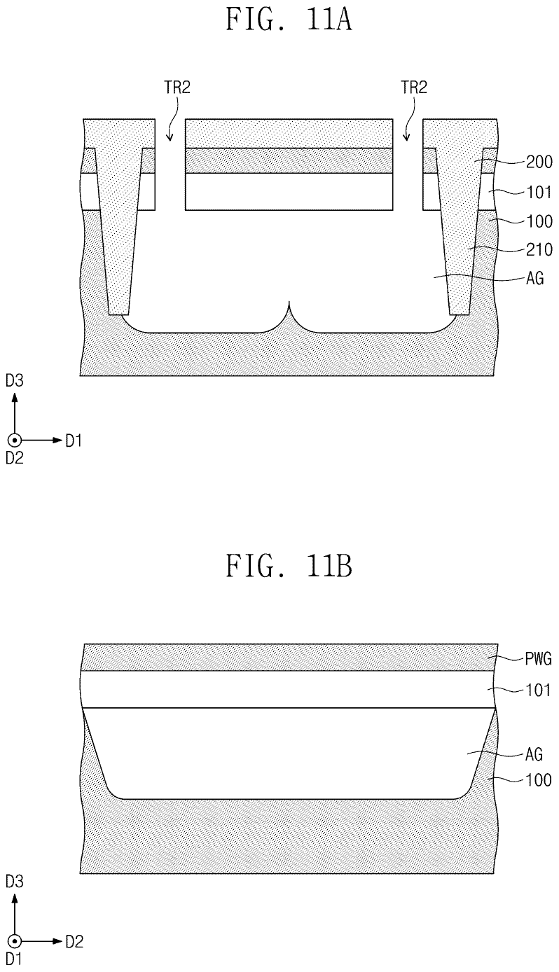

FIGS. 11A and 11B are cross-sectional views illustrating a method of manufacturing a semiconductor device according to an embodiment of the inventive concept. FIG. 11A is a cross-sectional view according to A-A′ of FIG. 1, and FIG. 11B is a cross-section view according to B-B′ of FIG. 1. For simplicity of description, details overlapping with the semiconductor device described with reference to FIGS. 4A to 8B are omitted.

Referring to FIGS. 11A and 11B, the air gap AG may be formed in the substrate 100 and may be formed between the plurality of first insulating patterns 210. Forming the air gap AG may include, for example, dry etching the substrate 100 through each of the plurality of second trenches TR2. The etching process may include, for example, isotropic etching.

The other manufacturing method may be substantially the same as the manufacturing method of the semiconductor device described with reference to FIGS. 4A to 8B.

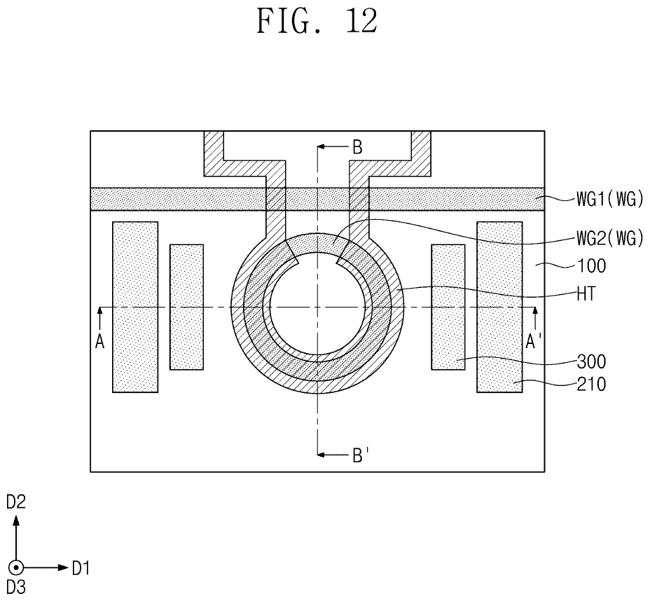

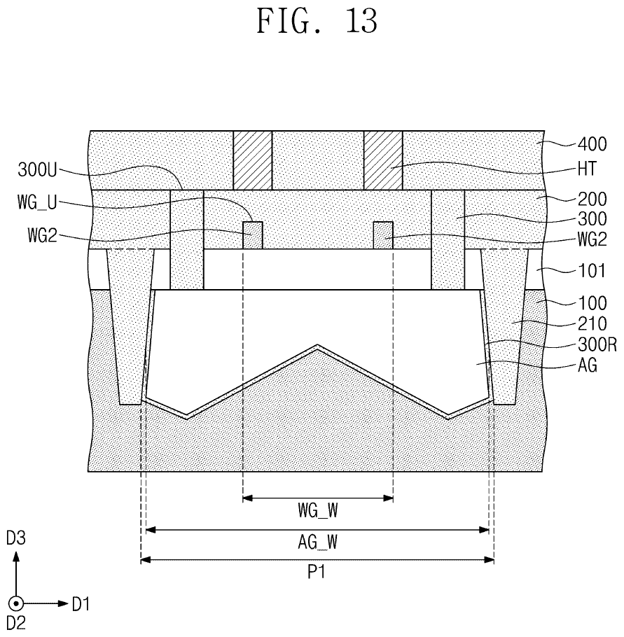

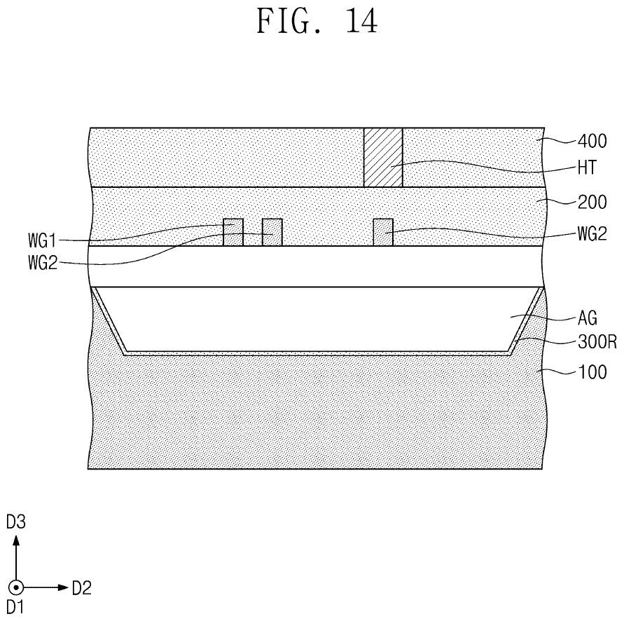

FIG. 12 is a plan view of a semiconductor device according to some embodiments of the inventive concept. FIG. 13 is a cross-sectional view according to A-A′ of FIG. 12. FIG. 14 is a cross-sectional view according to B-B′ of FIG. 12. For simplicity of description, details overlapping with the semiconductor device described with reference to FIGS. 1 to 3 are omitted.

Referring to FIGS. 12 through 14, the optical waveguide WG according to some embodiments of the inventive concept may include a first optical waveguide WG1 extending in the first direction D1 and a second optical waveguide WG2 having a columnar shape. The second optical waveguide WG2 may have a columnar shape including a through hole penetrating the center thereof. The semiconductor device according to some embodiments of the inventive concept may have a Micro Ring Modulator structure.

The first optical waveguide WG1 and the second optical waveguide WG2 may be disposed on the first insulating layer 101. The second insulating layer may cover the first optical waveguide WG1 and the second optical waveguides WG2. The upper surface WG_U of the first optical waveguide WG1 and the upper surface WG_ U of the second optical waveguides WG2 may be coplanar with each other. Each top surface WG_U of the first and second optical waveguides WG1 and WG2 may be located at a lower level than upper surface 300U of each of the plurality of second insulating patterns 300. The first optical waveguide WG1 and the second optical waveguides WG2 may include a semiconductor material, and may include silicon.

The first optical waveguide WG1 may be spaced apart from the plurality of first insulating patterns 210 and the plurality of second insulating patterns 300 in the second direction D2. The first optical waveguide WG1 may be spaced apart from the second optical waveguides WG2 in the second direction D2. The second optical waveguide WG2 may be interposed between the plurality of first insulating patterns 210 and may be interposed among the plurality of second insulating patterns 300. The second optical waveguide WG2 may be spaced apart from each of the plurality of first and second insulating patterns 210 and 300 in the first direction D1.

The heater HT may be disposed on the second insulating layer 200, and may be disposed on the first optical waveguide WG1 and the second optical waveguide WG2. The heater HT may overlap the second optical waveguide WG2 vertically (for example, the third direction D3), and may overlap a part of the first optical waveguide WG1vertically.

The air gap AG may be disposed in the substrate 100 and may be interposed between the plurality of first insulating patterns 210. The air gap AG may overlap the second optical waveguide WG2 and the heater HT vertically (for example, in the third direction D3). The air gap AG may overlap a portion of the first optical waveguide WG1 vertically (for example, the third direction D3). The width AG_W of the air gap AG in the first direction D1 may be greater than a width WG_W of the optical waveguide WG in the first direction D1. The width WG_W of the optical waveguide WG in the first direction D1 may mean a diameter of the second optical waveguide WG2, for example.

Other configurations may be substantially the same as the semiconductor device described with reference to FIGS. 1 to 3.

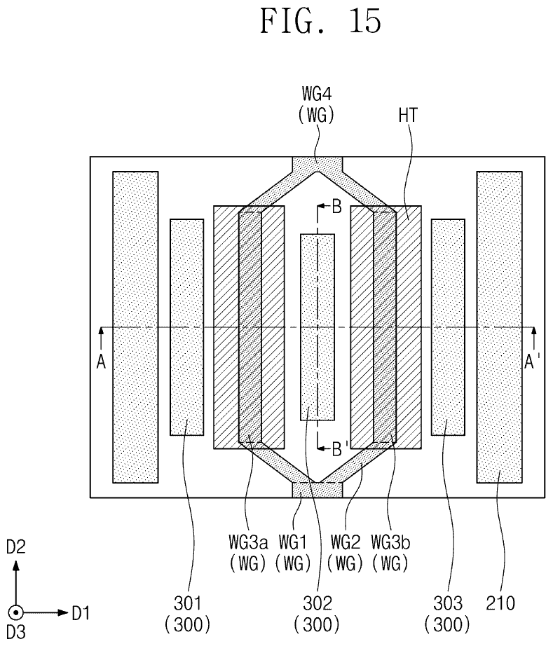

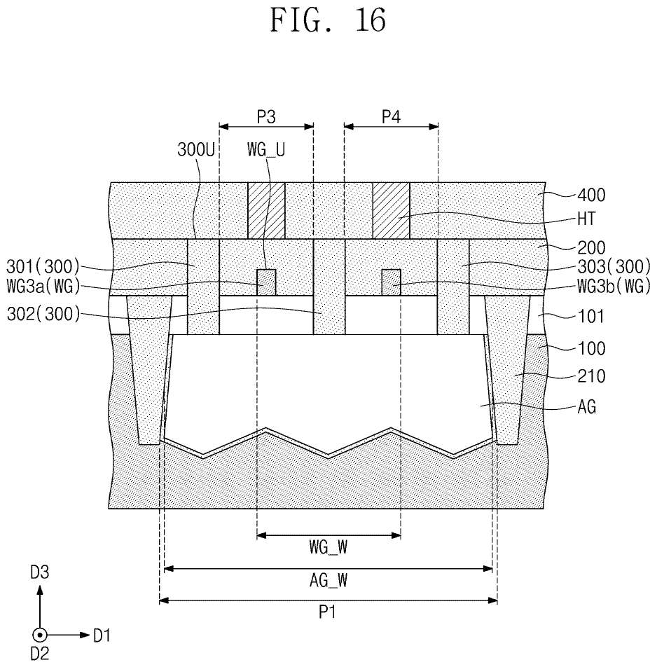

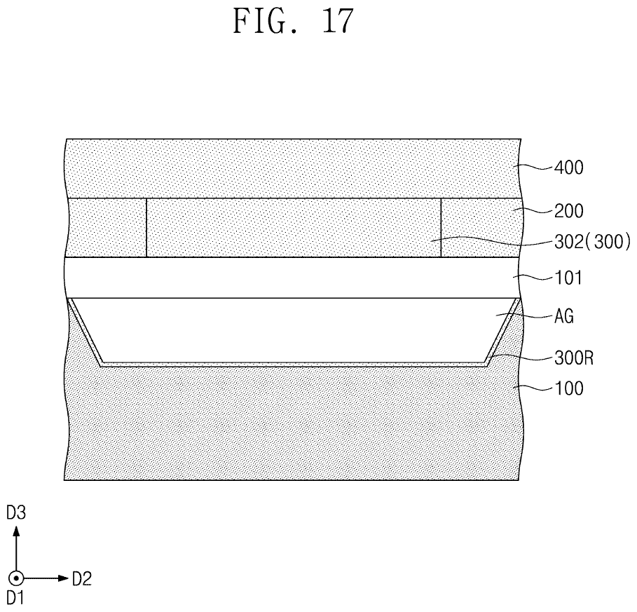

FIG. 15 is a top view of a semiconductor device according to some embodiments of the inventive concept. FIG. 16 is a cross-sectional view according to A-A′ of FIG. 15. FIG. 17 is a cross-sectional view according to B-B′ of FIG. 15. For simplicity of description, details overlapping with the semiconductor device described with reference to FIGS. 1 to 3 are omitted.

Referring to FIGS. 15 through 17, the optical waveguide WG according to some embodiments of the inventive concept may include a first optical waveguide WG1, a second optical waveguide WG2, a first linear optical waveguide WG3a, a second linear optical waveguide WG3b, and a merging optical waveguide WG4. The upper surfaces WG_U of the first optical waveguide WG1, the second optical waveguide WG2, the first linear optical waveguide WG3a, the second linear optical waveguide WG3b, and the merging optical waveguide WG4 may be coplanar with each other. The first optical waveguide WG1 may be in the form of a bar extending in the first direction D1.

Each of the first and second linear optical waveguides WG3a, WG3b may extend in the second direction D2 and may have a bar shape extending in the first direction D2. The first linear optical waveguide WG3a and the second linear optical waveguide WG3b may be spaced apart from each other in the first direction D1. The first linear optical waveguide WG3a and the second linear optical waveguide WG3b may be spaced apart from the first optical waveguide WG1 in the second direction D2.

The second optical waveguide WG2 may connect the first optical waveguide WG1 to the first linear optical waveguide WG3a, and may connect the first optical waveguide WG1 to the second linear optical waveguide WG3b. The second optical waveguide WG2 may be interposed between the first linear optical waveguide WG3a and the first optical waveguide WG1, and between the second linear optical waveguide WG3b and the first optical waveguide WG1. The second optical waveguide WG2 may have, for example, a Y-shape.

The merging optical waveguide WG4 may connect the first linear optical waveguide WG3a and the second linear optical waveguide WG3b. The merging optical waveguide WG4 may have, for example, a Y-shape. That is, the semiconductor device according to some embodiments of the inventive concept may have a Mach-Zehnder modulator structure.

The plurality of second insulating patterns 300 may include a first pattern 301, a second pattern 302, and a third pattern 303. The upper surfaces 300U of the first to third patterns 301, 302, and 303 may be coplanar with each other, and may be located at a higher level than the upper surface WG_U of the optical waveguide WG. Each of the first, second, and third patterns 301, 302, and 303 may extend in the second direction D2 and may penetrate the second insulating layer 200 and the first insulating layer 101. The first to third patterns 301, 302, and 303 may be spaced apart from each other in the first direction D1. The first pattern 301 and the third pattern 303 may be a pattern adjacent to the plurality of first insulating patterns 210. The first pattern 301 and the second pattern 302 may be spaced apart from each other by a third distance P3 in the first direction D1, and the second pattern 302 and the third pattern 303 may be spaced away from each other by a fourth distance P4 in the first direction D1. The third distance P3 and the fourth distance P4 may be the same as each other, but the inventive concept is not limited thereto. The third distance P3 and the fourth distance P4 may be different from each other. Each of the third distance P3 and the fourth distance P4 may be smaller than the first distance P1.

The first linear optical waveguide WG3a may be interposed between the first pattern 301 and the second pattern 302. The second linear optical waveguide WG3b may be interposed between the second pattern 302 and the third pattern 303. The second pattern 302 may be interposed between the first linear optical waveguide WG3a and the second linear optical waveguide WG3b.

The heater HT may be disposed on the second insulating layer 200 and may overlap the first linear optical waveguide WG3a and the second linear optical waveguide WG3b vertically (for example, in the third direction D3). The refractive index of the first linear optical waveguide WG3a or the second linear optical waveguide WG3b may be controlled through the heater HT.

The air gap AG may be disposed in the substrate 100 and may be interposed between the plurality of first insulating patterns 210. The air gap AG may overlap the optical waveguide WG and the heater HT vertically (for example, in the third direction D3). The air gap AG may overlap the first linear optical waveguide WG3a and the second linear optical waveguide WG3b vertically (for example, in the third direction D3). A plurality of lowermost surfaces AG_L of the air gap AG may be provided. Each of the plurality of lowermost surfaces AG_L of the air gap AG may overlap each of the plurality of second insulating patterns 300 vertically (for example, the third direction D3). That is, each of the first pattern 301, the second pattern 302, and the third pattern 303 may overlap with each of the plurality of lowermost surfaces AG_L of the air gap AG in a vertical direction (for example, the third direction D3).

The width AG_W of the air gap AG in the first direction D1 may be greater than the width WG_W of the optical waveguide WG in the first direction D1. The width WG_W of the optical waveguide WG in the first direction D1 may mean a width from the first linear optical waveguide wG3a to the second linear optical waveguide WG3b. The width AG_W of the air gap AG in the first direction D1 may be greater than each of the third distance P3 and the fourth distance P4. The width AG_W of the air gap AG in the first direction D1 may be smaller than or equal to the first distance P1. The air gap AG may be formed through isotropic dry etching.

Other structures may be substantially the same as the semiconductor devices described with reference to FIGS. 1-3.

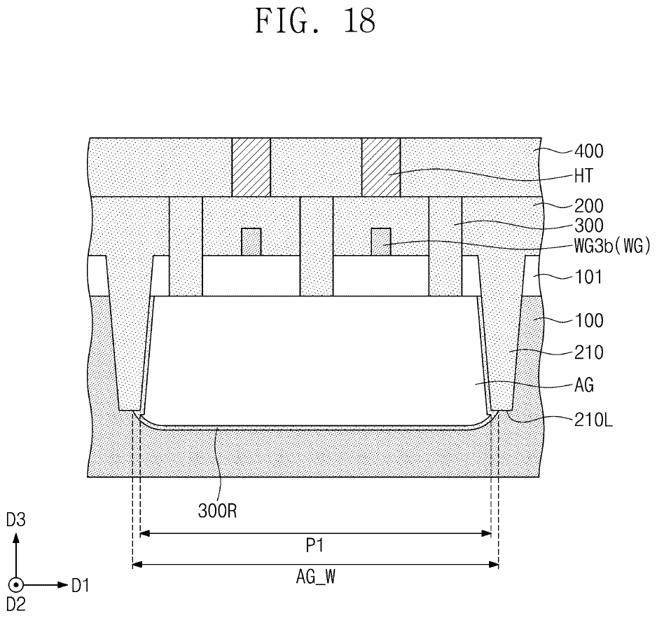

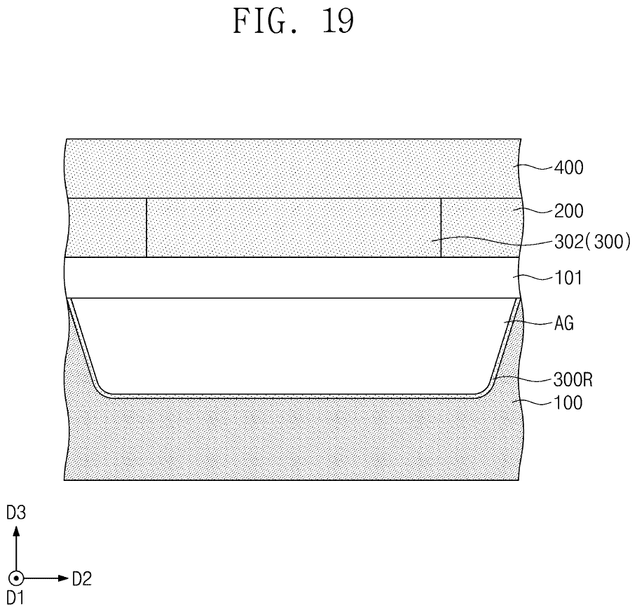

FIG. 18 is a cross-sectional view of a semiconductor device according to some embodiments of the inventive concept, in accordance with A-A′ of FIG. 15. FIG. 19 is a cross-sectional view of a semiconductor device according to some embodiments of the inventive concept, in accordance with B-B′ of FIG. 15. For simplicity of description, details overlapping with the semiconductor device described with reference to FIGS. 1 to 3 are omitted.

Referring to FIGS. 18 and 19, the air gap AG may be disposed in the substrate 100 and may be interposed between the plurality of first insulating patterns 210. The lower surface of the air gap AG may be rounded.

The air gap AG may expose the side surface 210S of each of the plurality of first insulating patterns 210, and may expose a portion of the lower surface 210L of each of the first insulating patterns 210. The maximum of the width AG_W of the air gap AG in the first direction D1 may be greater than the maximum of the first distance P1.

The insulating liner 300R may cover each side surface 210S of the plurality of first insulating patterns 210 and may extend along the substrate 100 exposed by the air gap AG. The insulating liner 300R may cover the exposed lower surface 210L of each of the plurality of first insulating patterns 210. Unlike shown, there may be no interface between the insulating liner 300R and the plurality of first insulating patterns 210.

Other configurations may be substantially the same as the semiconductor device described with reference to FIGS. 15-17.

According to embodiments of the inventive concept, the plurality of first insulating patterns 210 may be formed through the substrate 100. The air gap AG may be formed after formation of the plurality of first insulating patterns 210. The air gap AG may be interposed between the plurality of first insulating patterns 210. The size (or width) of the air gap AG may be defined by a plurality of first insulation patterns 210. As a result, an excessive formation of the air gap AG may be prevented. Thus, the mechanical stability of the semiconductor device may be improved. In a post-processing such as package assembly, a defect such as breakage of the semiconductor device may not occur.

Each of the aforementioned measurements (e.g., P1, P2, P3, AG_W, 101W, WG_W, 210W, etc.) may be obtained using a cross-section analysis method. In one example, the term “distance” between two targeted surfaces may refer to an average, maximum, or minimum value among measurements taken at multiple points (e.g., five points) between the two surfaces, either at equal or non-equal intervals. For instance, the second distance P2 may represent the minimum distance measured between the side surfaces of two adjacent second insulating patterns 300 that face each other, with the measurements taken at multiple locations (e.g., five) along the first direction D1. Similarly, the “width” of a component may refer to a dimension measured, in a horizontal direction parallel to a planar surface of the component, at a specific point along one of its side surfaces. These measurement methods are provided by way of example only and are not intended to be limiting. One of ordinary skill in the art may select the number of measurement points, the spacing between them, and other parameters as needed. For example, the number of measurement points per distance may be three, five, ten, or another suitable number. In one embodiment, measurements may be performed using an optical microscope or a scanning electron microscope (SEM); however, the present disclosure is not limited to these tools. Other measurement methods or instruments known to those skilled in the art may also be employed, even if not expressly described herein.

A method of manufacturing a semiconductor device according to some embodiments of the inventive concepts may comprises, forming a first insulating layer on a substrate and a preliminary optical waveguide layer on the first insulating layer, patterning the substrate, the first insulating layer, and the preliminary optical waveguide layer to form a plurality of first trenches; forming a plurality of first insulating patterns filling the plurality of first trenches and a second insulating layer on the preliminary optical waveguide layer, forming a second trench penetrating the first insulating layer and the preliminary optical waveguide layer and the second insulating layer, etching the substrate through the second trenches to form an air gap, forming a second insulating pattern filling the second trench, and patterning the preliminary optical waveguide layer to formed an optical waveguide.

According to some embodiments of the inventive concept, forming the air gap may include a wet etching process.

According to some embodiments of the inventive concept, the air gap may expose a side surface of each of the plurality of first insulating patterns and a lower surface of the first insulating layer.

According to some embodiments of the inventive concept, the manufacturing method further comprises forming a heater that vertically overlaps the optical waveguide and the air gap.

According to some embodiments of the inventive concept, the air gap may be interposed between the plurality of first insulating patterns.

According to some embodiments of the inventive concept, the optical waveguide may be interposed between the plurality of first insulating patterns.

While the embodiments of the present invention have been described above with reference to the accompanying drawings, it will be understood by those skilled in the art that the present invention may be embodied in other specific forms without altering the technical spirit or essential features thereof. It is, therefore, to be understood that the embodiments described above are illustrative in all respects and not restrictive.

What is claimed is:

1. A semiconductor device comprising:
a substrate;
a first insulating layer on the substrate;
an optical waveguide on the first insulating layer;
a second insulating layer on the first insulating layer;
a plurality of first insulating patterns extending from the second insulating layer toward the substrate and spaced apart from each other in a first direction parallel to an upper surface of the substrate;
a second insulating pattern disposed on the substrate and penetrating the first insulating layer and the second insulating layer; and
an air gap disposed in the substrate and interposed between the plurality of first insulating patterns,
wherein each of the plurality of first insulating patterns penetrates the substrate,
wherein an upper surface of the second insulating pattern is located at a higher level than an upper surface of the optical waveguide.

2. The semiconductor device of claim 1, wherein at least a portion of a lowermost surface of the air gap is located at a lower level than a lower surface of each of the plurality of first insulating patterns.

3. The semiconductor device of claim 1, wherein the second insulating pattern is spaced apart from the optical waveguide in the first direction.

4. The semiconductor device of claim 1, wherein a lower surface of the second insulating pattern is exposed by the air gap.

5. The semiconductor device of claim 1, wherein the upper surface of the second insulating pattern is located at a higher level than an upper surface of the first insulating layer.

6. The semiconductor device of claim 1, wherein the second insulating pattern is interposed between the plurality of first insulating patterns.

7. The semiconductor device of claim 1, wherein the air gap exposes a lower surface of the first insulating layer, and
a width of a lower surface of the exposed first insulating layer in the first direction is smaller than a maximum of a width of the air gap in the first direction.

8. The semiconductor device of claim 1, wherein the plurality of first insulating patterns is spaced apart from each other by a first distance in the first direction, and
the first distance increases as it approaches a lower surface of each of the plurality of first insulating patterns.

9. The semiconductor device of claim 8, wherein:
a maximum of a width of the air gap in the first direction is smaller than or equal to a maximum of the first distance.

10. The semiconductor device of claim 1, wherein the second insulating layer covers the optical waveguide, and
an upper surface of the second insulating layer is located at a higher level than the upper surface of the optical waveguide.

11. A semiconductor device comprising:
a substrate;
a first insulating layer on the substrate;
an optical waveguide on the first insulating layer;
a second insulating layer on the first insulating layer;
a plurality of first insulating patterns extending from the second insulating layer toward the substrate and spaced apart from each other in a first direction parallel to an upper surface of the substrate;
a plurality of second insulating patterns disposed on the substrate and penetrating the first insulating layer and the second insulating layer; and
an air gap disposed in the substrate and interposed between the plurality of first insulating patterns,
wherein each of the plurality of first insulating patterns penetrates the substrate,
wherein each of the plurality of second insulating patterns is interposed between the plurality of first insulating patterns,
wherein the optical waveguide is interposed between the plurality of second insulating patterns.

12. The semiconductor device of claim 11, wherein an upper surface of each of the plurality of second insulating patterns is located at a higher level than an upper surface of the optical waveguide.

13. The semiconductor device of claim 11, wherein the plurality of first insulating patterns are spaced apart from each other by a first distance in the first direction, and
the plurality of second insulating patterns is spaced apart from each other by a second distance in the first direction,
wherein the second distance is smaller than the first distance.

14. The semiconductor device of claim 13, wherein the second distance is smaller than a width of the air gap in the first direction.

15. The semiconductor device of claim 11, wherein the air gap exposes a lower surface of each of the plurality of second insulating patterns.

16. The semiconductor device of claim 11, wherein the plurality of first insulating patterns and the plurality of second insulating patterns comprise silicon oxide.

17. The semiconductor device of claim 11, further comprising a heater on the optical waveguide,
wherein the heater vertically overlaps the air gap,
wherein the optical waveguide vertically overlaps the air gap.

18. A semiconductor device comprising:
a substrate;
a first insulating layer on the substrate;
an optical waveguide on the first insulating layer;
a second insulating layer on the first insulating layer and covering the optical waveguide;
a plurality of first insulating patterns extending from the second insulating layer toward the substrate and spaced apart from each other in a first direction parallel to an upper surface of the substrate;
a second insulating pattern disposed on the substrate and penetrating through the first insulating layer and the second insulating layer;
an air gap disposed in the substrate and interposed between the plurality of first insulating patterns; and
a heater on the second insulating layer,
wherein the optical waveguide vertically overlaps the air gap,
wherein each of the plurality of first insulating patterns penetrates the substrate,
wherein an upper surface of the second insulating pattern is located at a higher level than an upper surface of the optical waveguide.

19. The semiconductor device of claim 18, wherein the plurality of first insulating patterns is spaced apart from each other by a first distance in the first direction, and
a maximum of a width of the air gap in the first direction is smaller than or equal to a maximum of the first distance.

20. The semiconductor device of claim 18, further comprising an insulating liner disposed on the air gap,
wherein the insulating liner covers a side surface of each of the plurality of first insulating patterns.
